(19) United States
(12) Patent Application Publication
(10) Pub. No.: US 2019/0227759 A1
(43) Pub. Date: Jul. 25, 2019

(54) INFORMATION PROCESSING SYSTEM, APPARATUS, AND INFORMATION PROCESSING METHOD

(71) Applicant: Seijiro Hori, Tokyo (JP)

(72) Inventor: Seijiro Hori, Tokyo (JP)

(21) Appl. No.: 16/248,829

(22) Filed: Jan. 16, 2019

(30) Foreign Application Priority Data
Jan. 25, 2018 (JP) 2018-010885

(51) Int. Cl. G06F 3/12

(52) U.S. Cl. CPC G06F 3/1238; G06F 3/1288; G06F 3/1286; G06F 3/1222

(57) ABSTRACT

An information processing system is connected to a plurality of networks. The information processing system includes a memory configured to store a plurality of instructions which, when executed by one or more processors, cause the one or more processors to: obtain user identification information identifying a user of the information processing system, the user identification information being input to the information processing system; determine a network corresponding to the user among the plurality of networks based on the user identification information that is obtained or information obtained in association with obtaining the user identification information; and control communication relating to a process requested by the user using the network that is determined among the plurality of networks.

### CROSS-REFERENCE TO RELATED APPLICATIONS

This patent application is based on and claims priority pursuant to 35 U.S.C. § 119(a) to Japanese Patent Application No. 2018-010885, filed on Jan. 25, 2018, in the Japan Patent Office, the entire disclosure of which is hereby incorporated by reference herein.

### BACKGROUND

### Technical field

The present disclosure relates to an information processing system, an apparatus, and an information processing method.

### Description of the Related Art

In order to ensure the security of information electronically managed within a company, there is a case of establishing a network permitting access from a guest as a visitor (hereinafter referred to as “guest network”) separately from and with no connection relationship with a network permitting access from an employee for in-house business (hereinafter referred to as an “employee network”) such as a local area network (LAN).

In this case, the guest uses an image forming apparatus connected to the guest network to causes the image forming apparatus to perform printing or the like based on a print request (print job) preliminarily registered in a computer (print server) connected to the guest network.

### SUMMARY

An information processing system is connected to a plurality of networks. The information processing system includes a memory configured to store a plurality of instructions which, when executed by one or more processors, cause the one or more processors to: obtain user identification information identifying a user of the information processing system, the user identification information being input to the information processing system; determine a network corresponding to the user among the plurality of networks based on the user identification information that is obtained or information obtained in association with obtaining the user identification information; and control communication relating to a process requested by the user using the network that is determined among the plurality of networks.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a network configuration, according to an embodiment of the present disclosure;

FIG. 2 is a diagram illustrating an example of a hardware configuration of an image forming apparatus, according to an embodiment of the present disclosure;

FIG. 3 is a diagram illustrating a functional configuration example of the image forming apparatus, according to an embodiment of the present disclosure;

FIGS. 4A and 4B (FIG. 4) are a sequence diagram illustrating an example of a processing procedure executed by the image forming apparatus, according to an embodiment of the present disclosure;

FIG. 5 is a diagram illustrating a configuration example of a user information storage, according to an embodiment of the present disclosure, and

FIG. 6 is a diagram illustrating a configuration example of a network setting storage, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

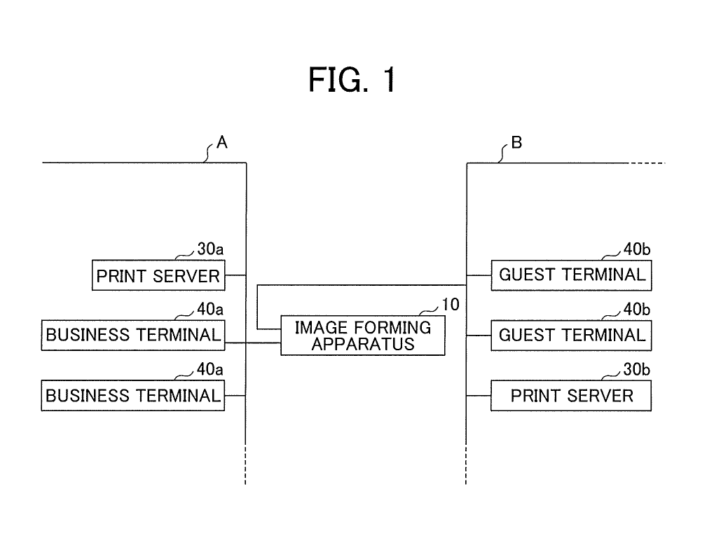

Hereinafter, embodiments of the present disclosure will be described with reference to the drawings. FIG. 1 is a diagram illustrating an example of a network configuration according to an embodiment of the present disclosure. In FIG. 1, an image forming apparatus 10 is connected to a network A such as a local area network (LAN) of a system A and connected to a network B of a system B. The network A and the network B are networks within a certain company (hereinafter referred to as a “company A”).

The network A is a business-use network for employees of the company A. In addition to the image forming apparatus 10, a print server 30a and one or more business terminals 40a are also connected to the network A. The business terminal 40a is a terminal such as a personal computer (PC), a tablet terminal, a smartphone used by an employee for business.

The print server 30a is a computer (device) that stores (accumulates), within the network A, data indicating a print request to be transmitted (uploaded) from the business terminal 40a (hereinafter simply referred to as a “print request”) in association with a “user name” of a user of the business terminal 40a as a transmission source of the print request. A print request contains information (Uniform Resource Locator (URL) or a path name) indicating a storage destination of data to be printed (hereinafter referred to as “print target data”), a document name of the print target data, print setting information, or the like. The print server 30a assigns identification information (hereinafter referred to as “job ID”) to each of the print requests and adds the job ID to each of the print requests. In response to a print request acquisition request from the image forming apparatus 10, the print server 30a transmits a print request list (hereinafter referred to as a “job list”) stored in association with the user name of the logged-in user of the image forming apparatus 10 included in the acquisition request, to the image forming apparatus 10.

The network B is an open network for a guest of the company A. The network B may be connected to the Internet. In addition to the image forming apparatus 10, a print server 30b and one or more guest terminals 40b are connected to the network B.

The guest terminal 40b is a terminal such as a personal computer (PC), a tablet terminal, or a smartphone used by a guest for the company A. A guest is a person other than an employee, for example, a visitor of a company A is an example of a guest. The guest terminal 40b may be brought by a guest or may be installed in advance.

The print server 30b is a computer that performs processing similar to that of the print server 30a based on a print request transmitted from the guest terminal 40b in the network A.

In the following description, arbitrary one of the network A and the network B is referred to as a “network X”, unless they have to be distinguished. In addition, arbitrary one of the print server 30a and the print server 30b is referred to as a “print server 30”, unless they have to be distinguished.

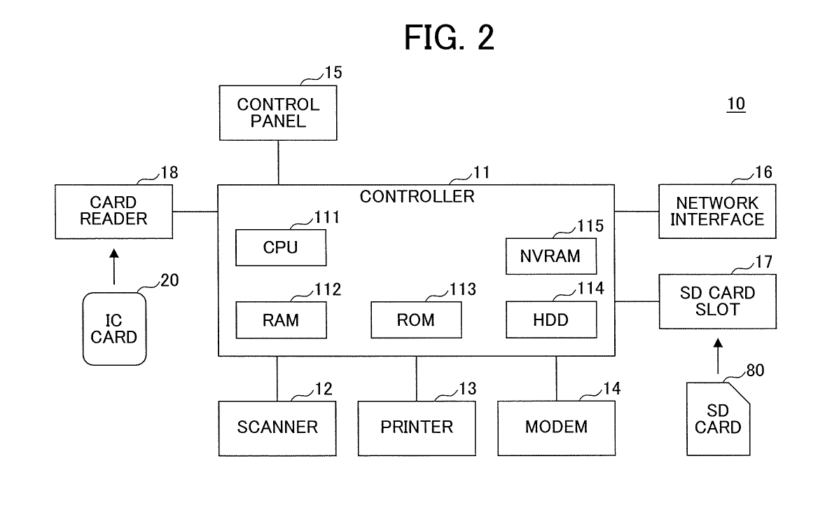

FIG. 2 is a diagram illustrating a hardware configuration example of the image forming apparatus 10 according to the embodiment of the present disclosure. In FIG. 2, the image forming apparatus 10 includes hardware components such as a controller 11, a scanner 12, a printer 13, a modem 14, a control panel 15, a network interface 16, a secure digital (SD) card slot 17, and a card reader 18.

The controller 11 includes a central processing unit (CPU) 111, a random access memory (RAM) 112, a read only memory (ROM) 113, a hard disk drive (HDD) 114, and a non-volatile random access memory (NVRAM) 115. The ROM 113 stores various programs and data used by the programs, or the like. The RAM 112 is used as a storage region for loading a program, a work region of a loaded program, or the like. The CPU 111, which is an example of a processor, processes the program loaded onto the RAM 112 to implement various functions. The HDD 114 stores programs and various types of data used by the programs. The NVRAM 115 stores various types of setting information, or the like.

The scanner 12 is a hardware component (image reading unit) for reading image data from a document. The printer 13 is a hardware component (printing unit) for printing print target data on a printing sheet. The modem 14 is a hardware component for connecting to a telephone line, applicable for executing transmission and reception of image data via facsimile communication. The control panel 15 is a hardware component including input units such as buttons for receiving inputs from the user and a display such as a liquid crystal panel. The liquid crystal panel may have a touch panel function. In this case, the liquid crystal panel also functions as an input unit. The network interface 16 is a hardware component for connecting to a network such as a LAN (regardless of whether it is wired or wireless). The SD card slot 17 is used for reading a program stored in the SD card 80. That is, in the image forming apparatus 10, not only the program stored in the ROM 113 but also the program stored in the SD card 80 can be loaded to the RANI 112 and executed. Note that the SD card 80 may be substituted by another recording medium (for example, a CD-ROM or a universal serial bus (USB) memory device). That is, the type of the recording medium corresponding to the category of the SD card 80 is not limited to a predetermined one. In this case, the SD card slot 17 may be substituted by a hardware component corresponding to the recording medium type.

The card reader 18 is a device that performs operation such as reading/writing information from/to the integrated circuit (IC) card 20. The card reader 18 may be incorporated in the image forming apparatus 10 or may be coupled to the image forming apparatus 10 via an external device connection interface such as a USB interface. The IC card 20 may be either a contact type or a non-contact type.

In the present embodiment, one IC card 20 is distributed to each of employees of the company A, one for each. In addition, the IC card 20 is lent to a guest of the company A at the time of visiting the company A, for example. That is, in the present embodiment, the user of the image forming apparatus 10 carries the IC card 20.

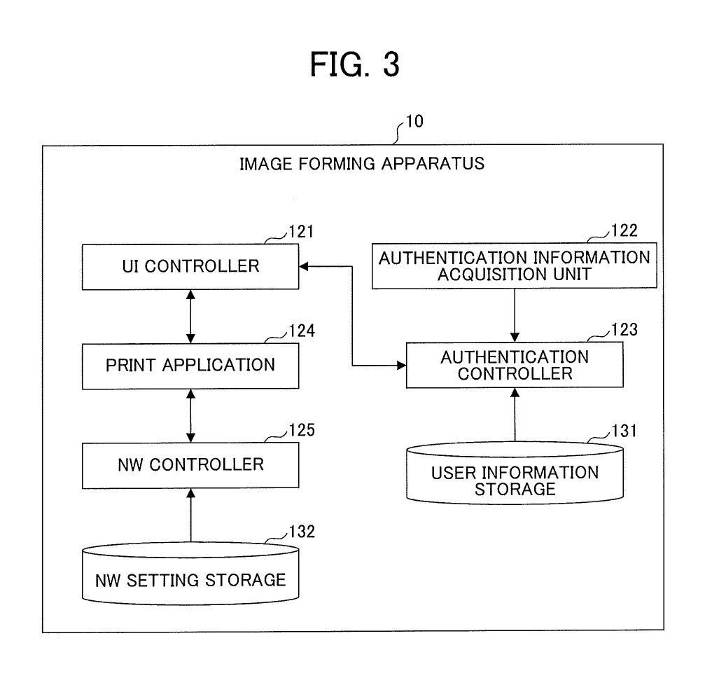

FIG. 3 is a diagram illustrating a functional configuration example of the image forming apparatus 10 according to the embodiment of the present disclosure. In FIG. 3, the image forming apparatus 10 includes a user interface (UI) controller 121, an authentication information acquisition unit 122, an authentication controller 123, a print application 124, and a network controller (NW controller) 125. These units are implemented by processing executed by the CPU 111 in accordance with one or more programs installed in the image forming apparatus 10. The image forming apparatus 10 also uses a user information storage 131, a network setting storage (NW setting storage) 132, or the like. Each of these storages can be implemented by using the HDD 114 or a storage connectable to the image forming apparatus 10 via a network, for example. Note that any one portion of the UI controller 121, the authentication information acquisition unit 122, the authentication controller 123, the print application 124, and the network controller 125 may be implemented by processing executed by an external computer connected to the image forming apparatus 10 via a communication line in accordance with a program installed in the computer.

The UI controller 121 displays information (such as a screen) on the control panel 15, and detects user's operation on the control panel 15.

The authentication information acquisition unit 122 obtains information stored in the IC card 20 (hereinafter referred to as “card information”) from the IC card 20 set in the card reader 18. The setting of the IC card 20 in the card reader 18 means enabling the card reader 18 to communicate with the IC card 20, such as inserting the IC card 20 into the card reader 18 or holding the IC card 20 over the card reader 18.

In the present embodiment, the card information includes a card ID and a card type. The card ID is identification information of the IC card 20, unique to each of the IC card 20. Therefore, the card ID is unique to each of the employee of company A. Accordingly, the card ID is equivalent to the identification information of the image forming apparatus 10. In contrast, the card ID of the IC card 20 lent to the guest may be used in common. The card type is information indicating whether the IC card 20 is an IC card distributed to an employee (hereinafter referred to as an “employee card”) or an IC card lent to a guest (hereinafter referred to as a “guest card”). In the present embodiment, the card type can take the value of “employee card” or “guest card”. Therefore, the card type can be defined as information for distinction of the category (employee or guest) of the carrier of the IC card 20 (the user of the image forming apparatus 10)

The authentication controller 123 checks the card ID included in the card information obtained by the authentication information acquisition unit 122 whether the card ID matches the card ID stored in the user information storage 131 so as to perform user authentication of the image forming apparatus 10.

The user information storage 131 stores user information (user name, etc.) related to the user in association with the card ID for each of users having been authorized to use the image forming apparatus 10. Note that user information including a user name such as “guest N” (N=1, . . . , n) or the like may be associated with the card ID of the guest card, for example.

In a case where print execution is requested by the user successful in authentication by the authentication controller 123 (hereinafter referred to as “logged-in user”), the print application 124 controls printing of print target data concerning the print request, stored in the print server 30.

The network controller 125 determines the network X to be used for communication based on the card type corresponding to the logged-in user, and uses the network X corresponding to the determination result to control communication relating to a process requested by the user. In the present embodiment, the network controller 125 obtains a job list corresponding to the logged-in user from the print server 30 connected to the network X corresponding to the determination result. In other words, when the logged-in user is an employee, the network controller 125 obtains a job list from the print server 30a connected to the network A. When the logged-in user is a guest, the network controller 125 obtains a job list from the print server 30b connected to the network B.

The network setting storage 132 stores information indicating the corresponding network X (hereinafter referred to as “network system information”) corresponding to the card type. That is, the network setting storage 132 stores information (association information) indicating the correspondence between the card type and the network X.

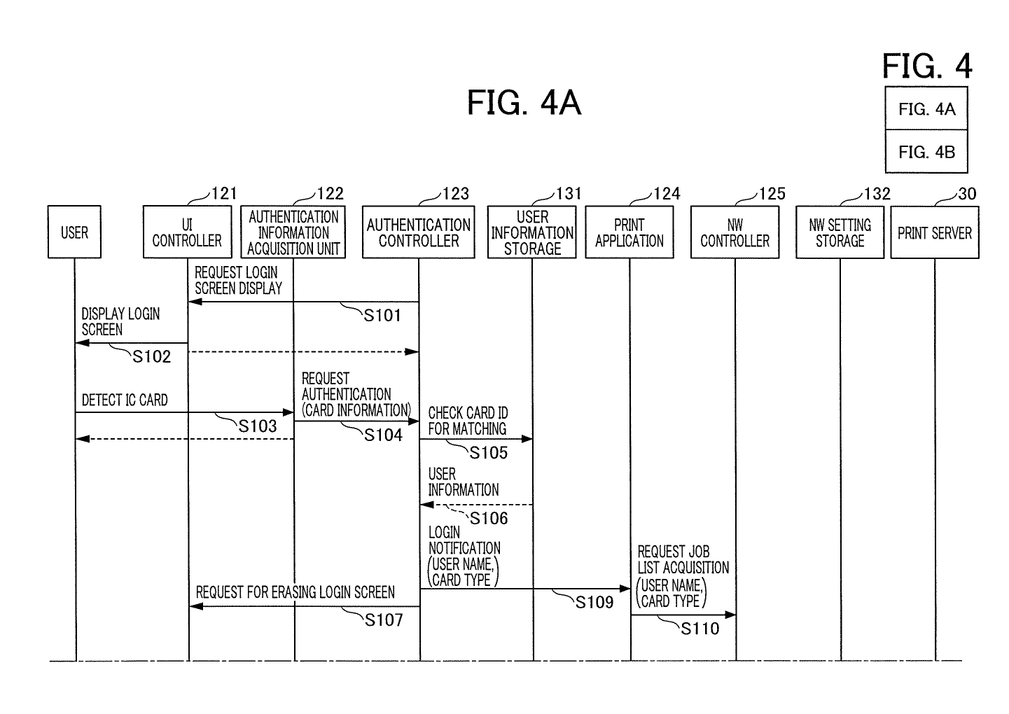

Hereinafter, a processing procedure executed by the image forming apparatus 10 will be described. FIG. 4 is a sequence diagram illustrating an example of a processing procedure executed by the image forming apparatus 10.

The authentication controller 123 requests the UI controller 121 to display a login screen at a timing after startup of the image forming apparatus 10 or after the user logout (S101), and then, the UI controller 121 displays a login screen on the control panel 15 (S102). The login screen may be a screen including a message prompting the user to set the IC card 20 on the card reader 18, for example. Displaying the login screen can restrict the use of the image forming apparatus 10.

Thereafter, the user sets the IC card 20 to the card reader 18 (S103), and then, the authentication information acquisition unit 122 detects that the IC card 20 has been set, reads the card information from the IC card 20, and inputs an authentication request including the card information to the authentication controller 123 (S104).

In response to the authentication request, the authentication controller 123 checks the card ID (hereinafter referred to as “target card ID”) included in the authentication request whether the card ID matches the card ID group stored in the user information storage 131 so as to determine whether the target card ID is stored in the user information storage 131 (S105).

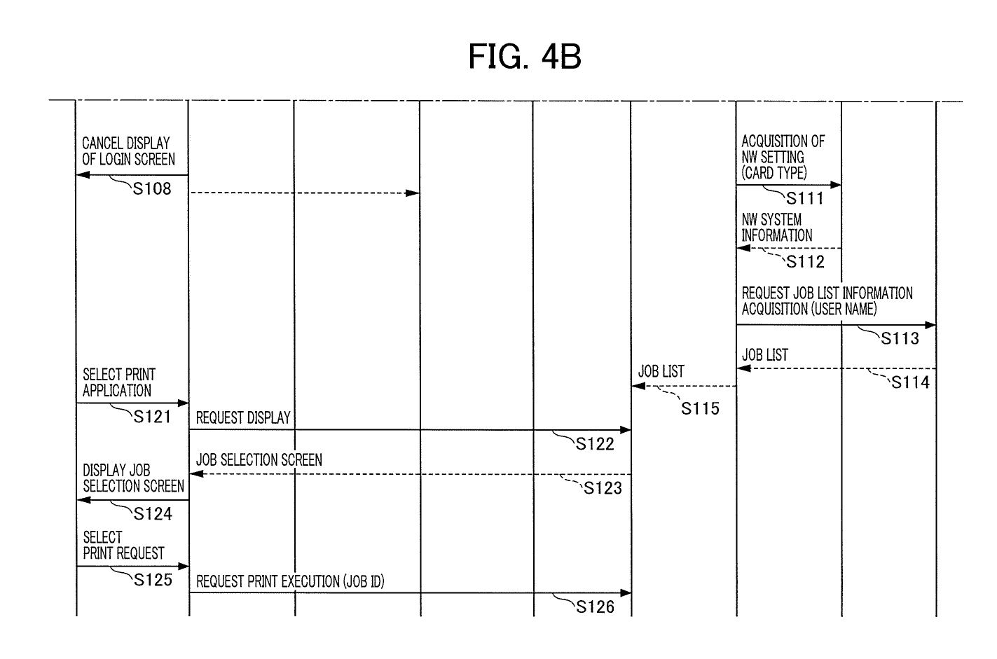

FIG. 5 is a diagram illustrating a configuration example of the user information storage 131. As illustrated in FIG. 5, the user information storage 131 stores user information including a user name in association with the card ID. FIG. 5 is an example in which the card ID of 9000 series is the card ID of a guest card.

In a case where the card ID matching the target card ID is not stored in the user information storage 131, the user authentication results in failure. In this case, the login screen remains displayed (use of the image forming apparatus 10 is still restricted).

In contrast, in a case where the card ID matching the target card ID is stored in the user information storage 131, the authentication controller 123 obtains the user name stored in association with the target card ID (hereinafter referred to as “target user name”) from the user information storage 131 (S106), and requests the UI controller 121 to erase the login screen (S107). In response to the request, the UI controller 121 erases the login screen (S108). As a result, for example, a home screen that was displayed behind the login screen becomes available for operation. The home screen is a screen displaying a list of icons corresponding to individual functions of the image forming apparatus 10 (for example, individual applications installed in the image forming apparatus 10).

The authentication controller 123 sends, to the individual applications installed in the image forming apparatus 10, such as the print application 124, a notification indicating that the user has logged in the image forming apparatus 10 (S109). The notification contains the target user name and the card type (hereinafter referred to as a “target card type”) included in the card information input in step S104.

In response to the notification, the print application 124 inputs a job list acquisition request to the network controller 125 (S110). The acquisition request includes the target user name and the target card type. The job list is a list of print requests uploaded to the print server 30.

Subsequently, the network controller 125 refers to the network setting storage 132 to identify the network X corresponding to the target card type. Specifically, the network controller 125 obtains the network system information associated with the target card type from the network setting storage 132 (S111 and S112).

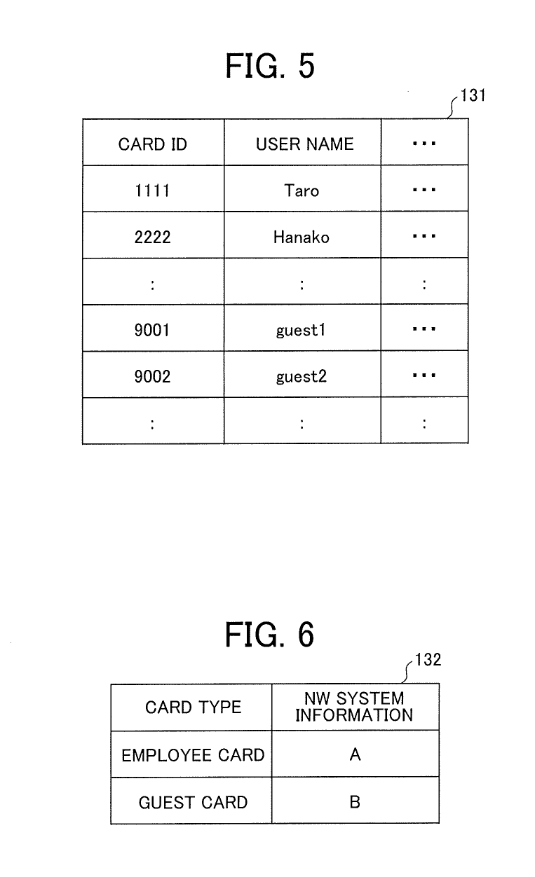

FIG. 6 is a diagram illustrating a configuration example of the network setting storage 132. As illustrated in FIG. 6, the network setting storage 132 stores network system information in association with the card type. The value of the network system information takes “A” or “B”. “A” indicates the network A. “B” indicates the network B.

Subsequently, the network controller 125 sends a job list acquisition request to the network X (hereinafter referred to as a “target network”) corresponding to the obtained network system information (S113). The acquisition request contains the target user name. Furthermore, an internet protocol (IP) address of the print server 30 is designated as a destination of the acquisition request. Therefore, when the network system information is “A”, the acquisition request is transmitted to the print server 30a. By contrast, when the network system information is “B”, the acquisition request is transmitted to the print server 30b. The IP address of each of the print servers 30 may be stored in association with the card type in the network setting storage 132, for example. Alternatively, a host name that is common to the print server 30a and the print server 30b may be set in advance in the image forming apparatus 10. The network controller 125 can specify the IP address of the print server 30 based on the host name. In this case, for example, a domain name system (DNS) server may be installed in each of the network A and the network B, and the network controller 125 may make an inquiry about the IP address to the DNS server connected to the target network.

In a case where the network controller 125 is implemented for each of applications, the network controller 125 may have information of the host name of the print server 30. The state of the network controller 125 having information of the host name is a state where the host name is stored in a file, a database (DB), or the like, under the control of the network controller 125. The file or the DB may be stored in the HDD 114, for example.

Meanwhile, in a case where the network controller 125 is shared by a plurality of applications, the print application 124 may have information of the host name of the print server 30. In this case, the host name of the print server 30 is preferably designated in the job list acquisition request in step S110.

The print server 30 that receives the job list acquisition request transmitted from the network controller 125 transmits, as a reply, a job list constituted with print requests associated with the user name included in the acquisition request out of the print requests stored in the print server 30 (S114).

In response to receiving the job list, the network controller 125 outputs the job list to the print application 124 (S115). The print application 124 stores the job list in the HDD 114, for example.

Thus, a series of processing procedures performed in response to the user's login ends. As a result, the image forming apparatus 10 transits to a standby state of waiting for user's input.

Thereafter, the UI controller 121 detects that an icon of the print application 124 has been selected from among the icons displayed on the home screen (S121), and then, the UI controller 121 requests the print application 124 to display a screen (operation screen of the print application 124) (S122). In response to the request, the print application 124 returns a screen containing the job list stored in the HDD 114 or the like (hereinafter referred to as a “job selection screen”) (S123). The job selection screen is a screen including, as choices, individual print requests included in the job list. While the present embodiment is an example in which steps S110 to S115 are executed before step S122 at the user's login, steps S110 to S115 may be executed in response to step S122

Subsequently, the UI controller 121 displays the job selection screen on the control panel 15 (S124). The UI controller 121 detects that one of the print requests is selected by the user from the job list and that a print execution instruction has been input (S125), and then, the UI controller 121 inputs a print execution request concerning the job ID included in the selected print request, to the print application 124 (S126). The print application 124 obtains the print target data concerning the print request including the job ID among the print requests included in the job list, and then, performs control for causing the image forming apparatus 10 to execute printing of the print target data.

As described above, according to the present embodiment, the network corresponding to the user of the image forming apparatus 10 is identified based on the card type obtained with the card ID from the IC card 20. Communication relating to a process requested by the user is performed using the identified network. Accordingly, it is possible to appropriately switch a network to be used by an apparatus (image forming apparatus 10) connected to a plurality of networks according to the user.

While the above description is an example in which the IC card 20 is used as an exemplary recording medium carried by the user, it is allowable to use another recording medium such as a magnetic card or a USB memory in place of the IC card 20.

Moreover, while the above description is an example in which the card type is stored in the IC card 20, the card type need not be stored in the IC card 20. In this case, the card type is stored in association with the card ID in the user information storage 131 or another storage, and the authentication controller 123 may obtain the card type corresponding to the target card ID from the user information storage 131 or the other storage.

Alternatively, the employee card and the guest card may be differentiated in the standard or specification. In this case, it would be sufficient to use a card reader capable of handling a plurality of types of standards or specifications as the card reader 18. The authentication information acquisition unit 122 obtains from the card reader 18 information indicating which standard or specification of a reading method was used by the card reader 18 to read the card information, and determines the card type based on the obtained information. Therefore, in this case, there is no need to store the correspondence between the card ID and the card type.

Meanwhile, the authentication method for logging in the image forming apparatus 10 is not limited to the method using an IC card. Authentication may use input of a user name and a password, or may use input of biometric information so as to specify the user name. In this case, the user information storage 131 may store information corresponding to the card type (for example, user category information for distinguishing whether it is an employee or a guest) in association with the user name, and the authentication controller 123 may determine whether the logged-in user is an employee or a guest based on the user name.

Moreover, the authentication controller 123 may request (delegate) execution of authentication processing to another computer (authentication server) connected to the image forming apparatus 10 via a network without executing authentication processing. In this case, the user information storage 131 may be included in the authentication server. The authentication server preferably executes processing similar to the case of the authentication controller 123 in response to an authentication request. Note that the network the authentication server is connected to may be the network A, or may be a third-system network other than the network A or the network B. In this case, the image forming apparatus 10 would be connected to three networks.

Moreover, while the present embodiment is an example in which the storage location (print server 30) of the print request, which is data related to the processing of the print application 124, is distinguished on the basis of the user category (employee or guest), an access destination of the data related to the processing of another application may be distinguished on the basis of the user category. For example, in the case of an application that executes a workflow, a server that stores workflow definition information may be connected to each of the network A and the network B, and the definition information acquisition destinations may be distinguished in accordance with the category of the logged-in user of the image forming apparatus 10. Furthermore, in the case of an application that causes the image forming apparatus 10 to execute scanning and stores the scanned image data in a predetermined server, the predetermined server may be connected to each of the network A and the network B, and the storage destination may be distinguished in accordance with the category of the logged-in user of the image forming apparatus 10.

While the present embodiment illustrates an example in which the image forming apparatus 10 is connected to two networks, the image forming apparatus 10 may be connected to three or more networks not mutually connected. Classification of user categories may be done based on criterion other than classification of employees and guests. For example, in a case where it is desired to suppress the information access across departments and desired to share the image forming apparatus 10 between the departments, the network used by the image forming apparatus 10 may be distinguished in accordance with the department to which the user belongs.

While the present embodiment describes the image forming apparatus 10 as an exemplary apparatus, the present embodiment can be applied to various apparatuses or information processing systems that access data stored in a computer connected via a network, such as a projector, an electronic whiteboard, and a video conference system.

It is not economical to separately install an image forming apparatus for employees and an image forming apparatus for guests. Therefore, it is conceivable to connect a single image forming apparatus to both the employee network and the guest network to reduce the economic burden. In this case, however, the image forming apparatus needs to switch networks to be used corresponding to the user. For example, the image forming apparatus needs to obtain a print request from a print server connected to the employee network when the user is an employee, and needs to obtain a print request from a print server connected to the guest network when the user is a guest.

The above issue is common to apparatuses using a network, not limited to an image forming apparatus.

According to one or more embodiments of the present disclosure, a network to be used by an apparatus connected to a plurality of networks is appropriately switched depending on a user.

Each of functions of the above-described embodiment can be implemented by one or more processing circuits. Here, the “processing circuit” in this specification represents a processor programmed to execute each of functions by software, such as a processor implemented by an electronic circuit, and devices such as an application specific integrated circuit (ASIC), a digital signal processor (DSP), a field programmable gate array (FPGA), or conventional circuit modules.

In the present embodiment, the image forming apparatus 10 is an example of an information processing system or an apparatus. Information such as the card ID, user name, biometric information, or the like included in the card information stored in the IC card 20 is an example of user identification information. The card type included in the card information stored in the IC card 20 or the reading method of the IC card 20 is an example of information obtained in association with obtaining the user identification information.

While the embodiment of the present disclosure has been described in detail as above, the present disclosure is not limited to such a specific embodiment, and various modification and alteration may be adopted within the scope of the present disclosure described in the claims.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. An information processing system that is connected to a plurality of networks, the information processing system comprising a memory configured to store a plurality of instructions which, when executed by one or more processors, cause the one or more processors to:
obtain user identification information identifying a user of the information processing system, the user identification information being input to the information processing system;
determine a particular network corresponding to the user among the plurality of networks based on the user identification information that is obtained or information obtained in association with obtaining the user identification information; and
control communication relating to a process that is requested by the user, using the particular network that is determined among the plurality of networks.

2. The information processing system according to claim 1,
wherein the one or more processors determine the particular network corresponding to the user among the plurality of networks by referring to association information stored in the memory, the association information indicating, for each of the plurality of networks, a correspondence between the network and the user identification information or the information obtained in association with obtaining the user identification information.

3. The information processing system according to claim 1,
wherein the one or more processors obtain the information from a recording medium carried by the user.

4. The information processing system according to claim 1,
wherein the one or more processors obtain data relating to the process from a device connected to the particular network that is determined among the plurality of networks.

5. The information processing system according to claim 1,
wherein the one or more processors transmits data relating the process to a device connected to the particular network that is determined among the plurality of networks.

6. An apparatus connected to a plurality of networks, the apparatus comprising a memory configured to store a plurality of instructions which, when executed by one or more processors, cause the one or more processors to:
obtain user identification information identifying a user of the apparatus, the user identification information being input to the apparatus;
determine a particular network corresponding to the user among the plurality of networks based on the user identification information that is obtained or information obtained in association with obtaining the user identification information; and
control communication relating to a process that is requested by the user, using the particular network that is determined among the plurality of networks.

7. An information processing method performed by an information processing system connected to a plurality of networks, the method comprising:
obtaining user identification information identifying a user of the information processing system, the user identification information being input to the information processing system;
determining a particular network corresponding to the user among the plurality of networks based on the user identification information that is obtained or information obtained in association with obtaining the user identification information; and
controlling communication relating to a process that is requested by the user, using the particular network that is determined among the plurality of networks.
